(19) United States
(12) Patent Application Publication
(10) Pub. No.: US 2015/0342385 A1
(43) Pub. Date: Dec. 3, 2015

(54) Holding Apparatus for Sheet-Like Elements, Which Holding Apparatus can be Fitted Without Tools

(71) Applicant: LAURENZ SIMBRUNER, WIEN (AT)

(72) Inventor: LAURENZ SIMBRUNER, WIEN (AT)

(21) Appl. No.: 14/760,261

(22) PCT Filed: Jan. 2, 2014
(86) PCT No.: PCT/EP2014/050009

§ 371 Date: Jul. 10, 2015

(30) Foreign Application Priority Data
Jan. 10, 2013 (AT) A 19/2013

(51) Int. Cl. A47H 1/142; E06B 9/42; E06B 9/02; A47H 1/022

(52) U.S. Cl. CPC A47H 1/142; A47H 1/022; E06B 9/42; E06B 9/02

(57) ABSTRACT

A holding apparatus for sheet-like elements, such as drapes, curtains, roller blinds, shutters, video walls and the like in front of a wall opening, can be fitted without tools. The holding apparatus includes an elongate support, a first clamping part engages into a soffit and has a receiving region for receiving the support. A second clamping part engages into the soffit and has a second receiving region for the support. A first thread on a clamping part meshes with a second thread on the support. An elongated, horizontal holding region receives the sheet-like element. A screw-in depth is varied by a relative movement of the first and second threads, in order to clamp the apparatus in the soffit and/or to change the distance between the clamping projections. The holding region is arranged above and outside the wall opening and projects laterally beyond the wall opening.

The invention relates to a holding apparatus, which can be installed without the use of tools, for sheetlike elements such as in particular drapes, curtains, roller blinds, shutters, projection screens and the like in front of a wall opening, comprising an elongate beam, a first clamping part which has a first clamping projection, for engagement into a reveal which delimits the wall opening, and a first receiving region for receiving the beam, a second clamping part which has a second clamping projection for engagement into the reveal and a second receiving region for receiving the beam, a first thread which is provided on a clamping part, a second thread which is provided on the beam and which is in meshing engagement with the first thread, and/or an elongate, substantially horizontally running holding region in which the sheetlike element can be arranged.

In the prior art, for the installation of sheetlike elements, such as for example drapes, curtains, roller blinds, projection screens and the like, use is made of holding apparatuses which are fastened to masonry by way of screw-wall plug connections. For example, curtain rails are known which are anchored in the masonry, in particular in the wall, above a window or door reveal by way of screws. Subsequently, sheetlike elements can be fastened to said apparatuses by way of rings, rails or similar holding systems. A disadvantage of this design is that, for this purpose, holes must be provided in the wall. Aside from the partial destruction of the masonry, adequate tooling and technical ability are required for the installation process.

Known holding apparatuses that can be installed without the use of tools are designed for example as clamping rods. Said clamping rods are constructed in the manner of telescopic tubes and have a compression spring in their interior. A spring is placed under stress by virtue of the telescopic rail being pushed together. The prestressed telescopic rail is subsequently inserted into the wall opening of a window, is released, and is braced in the window reveal. Thereafter, it is possible for the sheetlike element to be mounted on the clamping rod for example by way of rings or other fastening means. A disadvantage of this apparatus which corresponds to the prior art is that the clamping rod is inserted directly into the window reveal. This restricts, for example, the opening capability of inwardly pivoting windows. Furthermore, in the case of curtains being used, it is not possible for these to be positioned laterally adjacent to the window or adjacent to the window reveal in order to provide a clearer view through the window.

The prior art also discloses curtain systems in which curtains are fastened directly to the window frame. For such apparatuses too, use is made of resiliently prestressed telescopic rails which are braced in the window frame. Since the sheetlike elements are connected directly to the window leafs, it is the case, if the window is opened, that the sheetlike elements are also opened, whereby visual screening and protection from sunlight are no longer provided.

It is now an object of the present invention to specify a holding apparatus for sheetlike elements, which holding apparatus overcomes the disadvantages of the prior art, and in particular can be installed without the use of tools, and the installation of which does not require the masonry to be damaged, wherein the sheetlike elements can be arranged outside the reveal and/or the masonry opening, such that, for example, windows or doors can be fully opened, and the sheetlike element, for example a curtain, can be positioned laterally adjacent to and outside the masonry opening and/or in front of the wall.

It is also an object of the invention to provide a holding apparatus for sheetlike elements, which holding apparatus can be flexibly adapted to different shapes of reveals, to different surfaces of reveals, to different reveal widths and to different sheetlike elements, and which furthermore is simple to install and cheap to produce.

The objects of the invention are achieved in particular in that, by a relative movement of the first thread with respect to the second thread, the screwing-in depth can be varied in order to effect clamping of the apparatus in the reveal and/or a change of the spacing between the clamping projections, in that the holding region is arranged above and outside the wall opening, and in that the holding region projects laterally beyond the wall opening.

Further advantageous features are that the first clamping part comprises a first spacer element which extends from the first clamping projection out of the reveal into a region to the side of and above the wall opening as far as the first receiving region, that the second clamping part comprises a second spacer element which extends from the second clamping projection out of the wall opening into a region to the side of and above the wall opening as far as the second receiving region, that at least one elastic element is provided which is compressed, and in particular elastically deformed, under the influence of the clamping force, that the elastic element is in the form of a compression spring, rubber buffer, elastic layer or friction-increasing layer, that the first clamping projection has at least one first contact region, that the second clamping projection likewise has at least one first contact region, and that the contact regions, in the installed position, are pressed against opposite regions of the reveal, and/or that each clamping part has at least one second contact region which, in the installed position, is arranged below the first contact region.

Also, advantageous combinations of features are that the second contact region, in the installed position, bears against the wall and/or is pressed against the reveal, that the clamping parts, in their receiving regions, each comprise a receiving bushing into which the beam can be and/or is inserted, that the second thread is rigidly connected to the beam, and that the spacing between the clamping projections and/or the clamping force can be varied by rotation of the beam, that the second clamping part comprises a third thread and the beam comprises a fourth thread, and that the third thread and the fourth thread are in meshing engagement with one another, and/or that the third thread and the fourth thread have a thread direction of rotation opposed to the thread direction of rotation of the first thread and of the second thread.

According to further advantageous refinements, it may be provided that the central axes of the threads run substantially coaxially, that the clamping projection comprises an elastic element which is pressed against the reveal, and in the process elastically deformed, by the clamping force, that the elastic element is provided in areal form, so as to follow the fixed part of the clamping projection, and at least in the contact region of the clamping part, that the beam is in the form of a circular-section rail, that the receiving bushing comprises a cylindrical opening (23), the inner diameter of which is greater than the outer diameter of the rail, that, in the cylindrical opening of the receiving bushing (19), and concentrically with respect to the cylindrical opening, there is provided a threaded rod which is connected to the base of the receiving bushing and is in particular screwed into the base, that a thread is provided on the beam, that the thread is in the form of an internal thread which is in meshing engagement with the threaded rod of the clamping part, that the central axis of the thread and the central axis of the beam run concentrically with respect to the central axis of the cylindrical opening, that the receiving bushing is connected, in the receiving region, to the spacer element, and that the holding region extends over a part of the bushing as far as the spacer element or as far as the holding groove, and/or that the holding region extends over the entire free length of the beam.

The apparatus according to the invention is in particular suitable and/or designed for the positioning of sheetlike elements such as, for example, drapes, curtains, roller blinds and shutters or other fitments in the region of a wall opening or of a reveal. For this purpose, the apparatus comprises a holding region in which the sheetlike element can be attached in fixed and/or movable fashion. Examples of holding apparatuses in the holding region are rods, rails, grooves, curtain rails etc. To enable the sheetlike element to be fastened or attached to the holding apparatus, use may be made of, for example, fixed rings, movable rings, curtain hooks, clips or other connecting means. Use is particularly preferably made of curtain rails with suitable curtain hooks for engagement into the curtain rails or curtain rods with curtain rings.

According to the invention, the sheetlike elements are preferably positioned outside the wall opening and the reveal. In this context, a reveal is defined as a surface which delimits the wall opening. The wall opening corresponds to an opening in a wall of any desired shape. Examples of wall openings and reveals are window openings with a window reveal or door openings with a door reveal. For example, in the case of a window reveal, the reveal is that surface which is substantially normal to the wall surface and which delimits the wall opening.

However, different forms of reveals, such as for example oblique or structured reveals, are also conceivable.

The holding apparatus comprises at least one, preferably two clamping parts. Furthermore, the apparatus comprises a beam. The holding region extends preferably over the entire beam, and if appropriate over parts of the clamping parts.

As examples of beams, use is made of rod-shaped bodies such as, for example, profiles, rails, circular-section rods, profiled rods etc.

For the installation of the holding apparatus, clamping projections are provided which can be placed in operative contact with the window reveal. In particular, two clamping projections are provided, the spacing of which to one another is variable. Furthermore, a clamping force can be generated with which the clamping projections can be pressed against different regions of the reveal. For installation, the clamping projections are inserted into the wall opening. By virtue of the spacing of the clamping projections with respect to one another being varied, said clamping projections are pressed preferably laterally against the window reveal.

The holding region of the holding apparatus is preferably provided outside the wall opening and above the wall opening. Furthermore, the holding region projects laterally beyond the window opening to a defined extent. This configuration yields the following advantages:

As a result of the positioning of the holding region outside and above the wall opening, the sheetlike element can be positioned such that it extends upward beyond the opening. If the holding region also extends laterally, in particular on both sides of the wall opening, beyond the reveal, the sheetlike element can also extends laterally beyond the wall opening. Furthermore, the positioning of the holding region outside the wall opening also creates the possibility for the sheetlike element to extend downward beyond the wall opening. Thus, by means of the present configuration, the sheetlike element can extend beyond the wall opening in all directions.

As a result of the positioning outside and above the wall opening, unhindered operability of any element situated in the wall opening is also maintained. Thus, it is for example possible for an inwardly opening window or an inwardly opening door to be opened unhindered when the holding apparatus is in installed state.

The projection laterally beyond the wall opening furthermore has the advantage that, in the case of curtains being used, the individual curtain parts can be positioned to the left and/or to the right of the reveal and of the wall opening. In this way, it is possible, if appropriate, for the sheetlike element to be positioned outside the clear width of the window.

For the arrangement of the holding region according to the invention, the clamping part comprises a spacer element. Said spacer element connects the clamping projection of the clamping part to the receiving region of the clamping part, which is intended for receiving or holding the beam. In this case, the spacer element projects from the clamping projection out of the reveal into a region to the side of and above the wall opening. The spacer element may be formed for example by bent metal elements such as for example steel, brass, aluminum and/or copper elements, by plastics parts, or else by wood parts.

To vary the spacing between the two clamping projections and/or to generate a clamping force, mechanical means for spacing variation are provided. For example, a first thread and a second thread are provided, wherein the two threads are in meshing engagement. By virtue of one element, on which a first thread is provided, being rotated relative to a second element, on which the second thread is provided, it is possible to realize a linear displacement in the axial direction of the thread. It is preferable for a thread to be provided on the clamping part and for a thread to be provided on the beam. By way of a relative movement between the beam and the clamping part, it is thus possible for the screwing-in depth of the thread to be varied. In this way, it is also possible for the spacing of one clamping projection to a further clamping projection to be varied, or for a clamping force to be generated.

It is preferable for a first clamping part to be provided on one end of the beam and for a second clamping part to be provided on another end of the beam. By virtue of the beam being moved, in particular rotated, about the thread axis, it is possible for the screwing-in depth, and thus also the spacing of the clamping projections, to be varied.

When both clamping projections, that is to say the first clamping projection of the first clamping part and the second clamping projection of the second clamping part, are bearing against the respective sides of the wall opening, in particular against the reveal, further rotation causes a clamping force to be generated. Said clamping force is also defined by a certain degree of elasticity of the apparatus, in particular of the beam, of the clamping parts and/or also of the reveal. By means of the clamping force, the clamping projections are pressed with a certain force against the window reveal, and the apparatus is braced in the reveal. In order that the load of a sheetlike element and the inherent weight of the holding apparatus can be supported, the contact region between the clamping projection and the reveal or the wall exhibits a certain friction force. Said friction force is defined firstly by the friction coefficient in the contact region and secondly by the clamping force. Altogether, the resultant friction force of all of the contact regions must be greater than the weight force of the sheetlike element and of the apparatus itself.

To increase the friction force, a friction-increasing element is preferably provided in the contact region. Said element may for example be in the form of an elastic element, a rubber layer, a rubber body, a silicone body, a silicone layer, a plastics body, a foam rubber layer, a foam rubber body or the like. In particular, the clamping projection or the contact region comprises an elastic element which is pressed against the reveal.

To increase security against undesired release of the apparatus, an elastic element is preferably provided which is elastically deformed and/or prestressed by the clamping force.

Said elastic element and the element which increases the friction force may either be a single element or may be formed by one or more elements.

Below, the invention will be described in more detail on the basis of specific exemplary embodiments.

For receiving the beam, receiving bushings are preferably provided. The beam can be inserted into said receiving bushings. The bushing has an opening which substantially corresponds to the external dimensions of the beam profile. Thus, the beam can be inserted with play, or with a certain fit, into the bushing. The bushing furthermore increases the stability of the holding apparatus, as the bushing is preferably of rigid design. Thus, the stability of the overall system is increased through the provision of longer or deeper receiving bushings. A further advantage of deeper receiving bushings is that, with the simultaneous provision of longer threaded rods, the flexibility of the length adaptation of the holding apparatus is also improved.

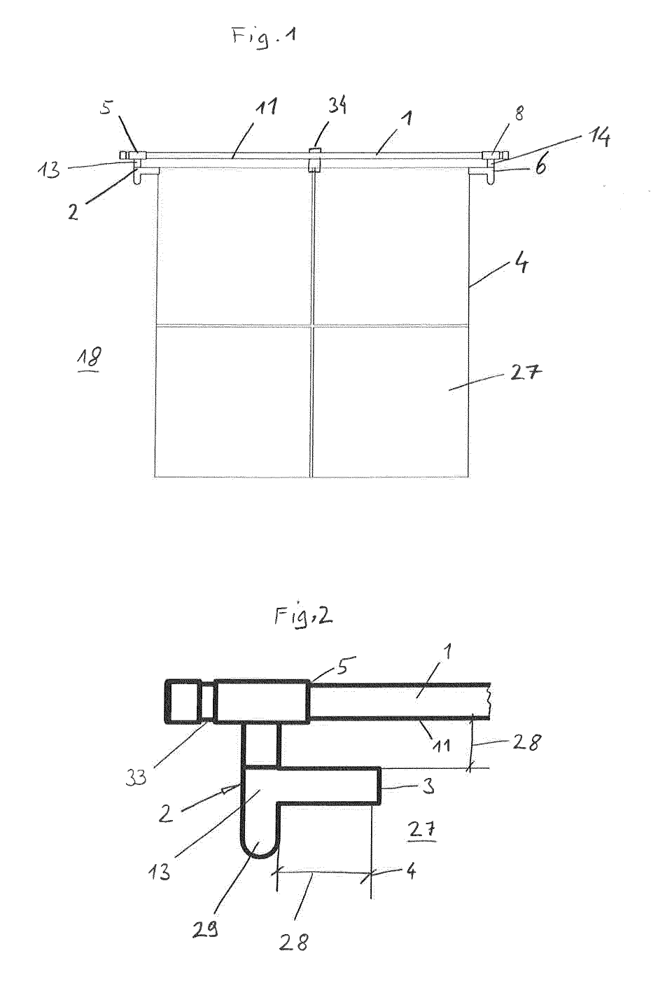

FIG. 1 shows a possible embodiment of the holding apparatus on a window reveal.

FIG. 2 shows a detail of a clamping part of the embodiment from FIG. 1.

FIG. 3 shows an oblique view of a clamping part, wherein the beam is not illustrated.

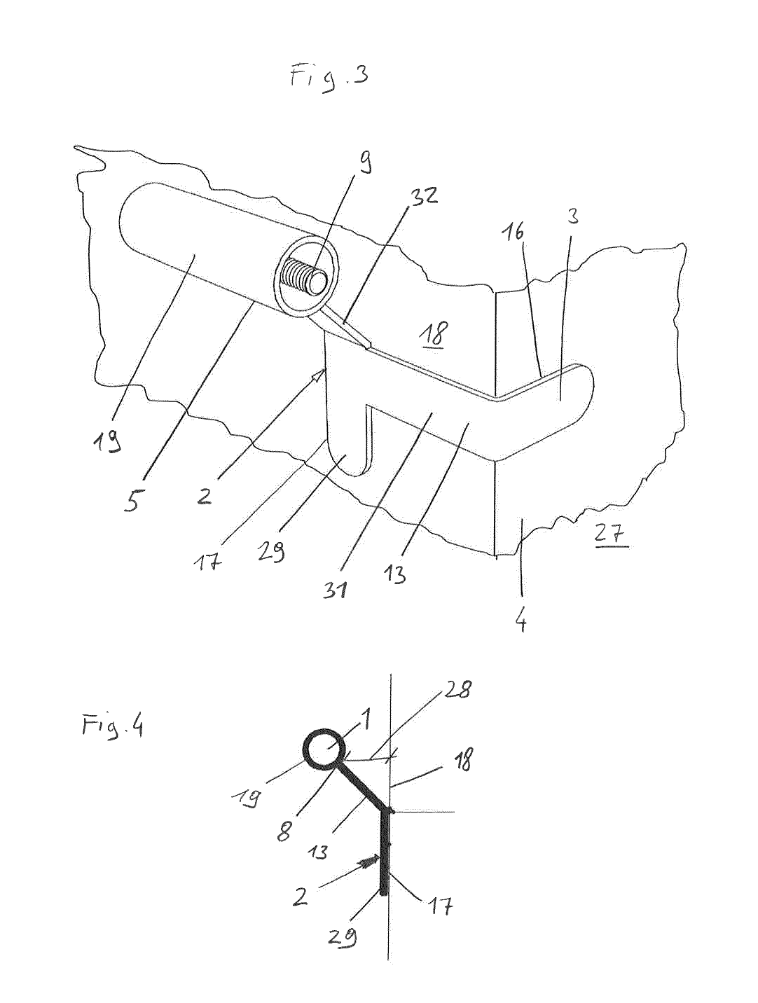

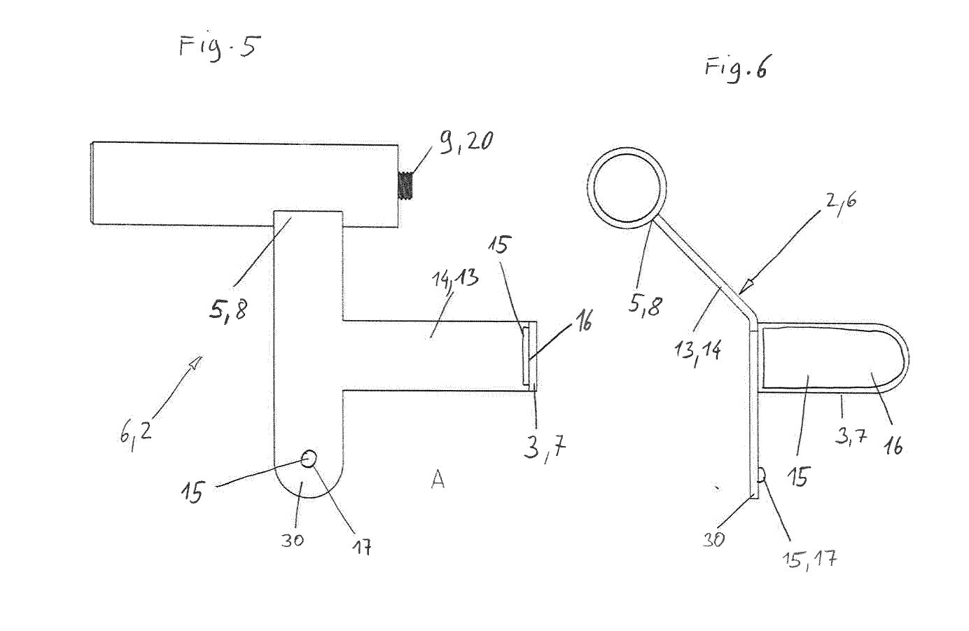

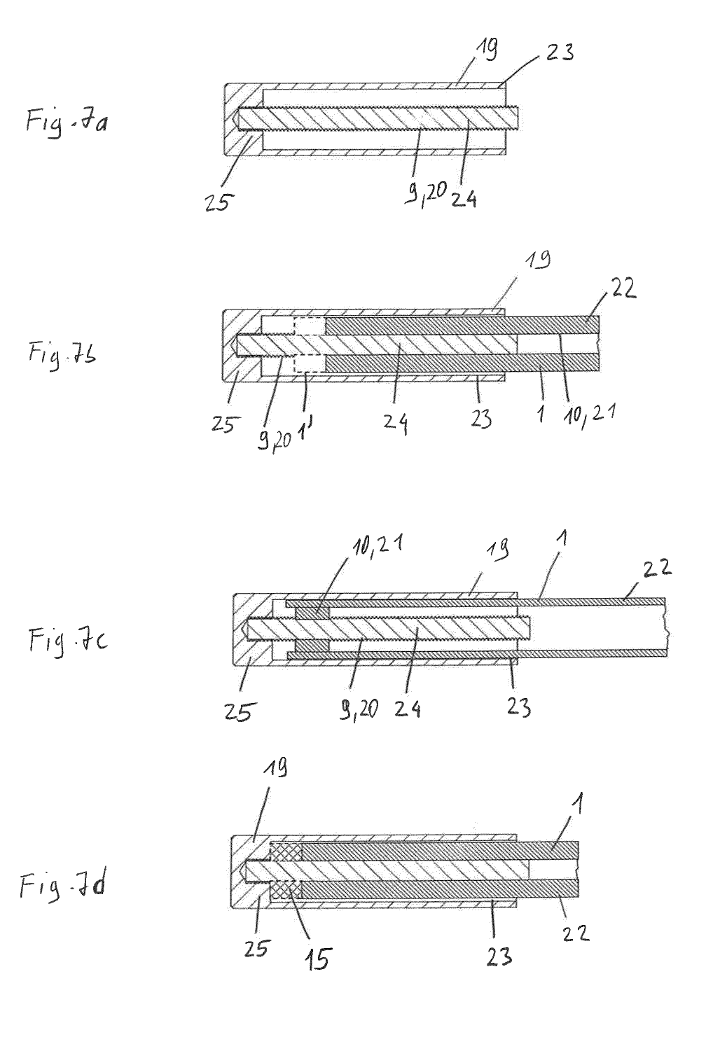

FIG. 4 shows a side view of the apparatus.

FIGS. 5 and 6 show detail views of the clamping part.

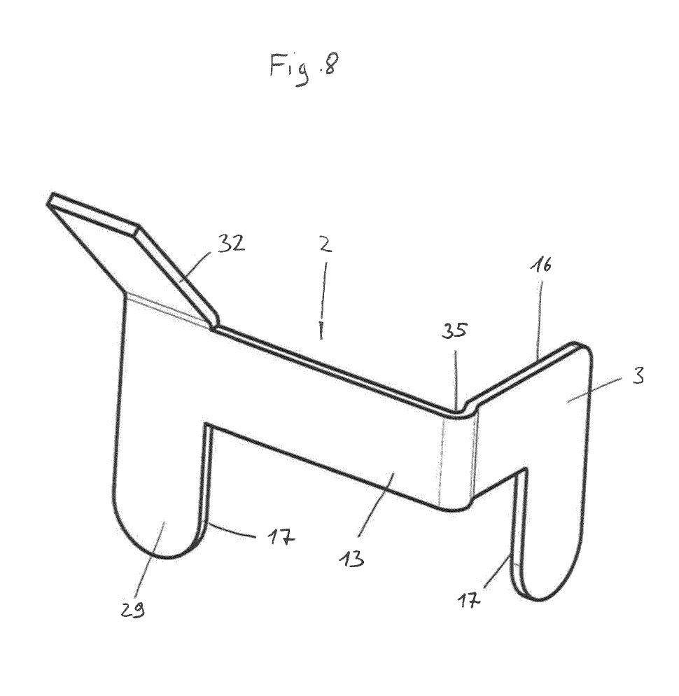

FIG. 7a shows a section through a part of a clamping part, in particular in the receiving region.

FIG. 7b shows the same section as FIG. 7a, but with a beam screwed in.

FIG. 7c shows a further embodiment in the same sectional illustration.

FIG. 7d shows a further embodiment in the same sectional illustration.

FIG. 8 shows a further embodiment of parts of a clamping apparatus.

FIG. 1 shows an embodiment of the holding apparatus according to the invention for sheetlike elements such as in particular drapes, curtains, roller blinds, shutters and the like, having a beam 1, having a first clamping part 2 and having a second clamping part 6. The clamping parts 2 and 6 engage into the reveal 4 of the wall opening 27. The beam is connected, in the first receiving region 5, to the first clamping part 2 and, in the second receiving region 8, to the second clamping part 6. The first clamping part 2 comprises a first spacer element 13, and the second clamping part 6 comprises a second spacer element 14.

Furthermore, the holding region 11 is provided on the apparatus. The holding region 11 is that region of the apparatus in which the sheetlike element (not illustrated) can be and/or is positioned. In the present embodiment, the holding region 11 extends from the first spacer element 13 to the second spacer element 14. Thus, the holding region 11 extends over the beam 1 and parts of the first and second clamping part 2, 6. Furthermore, the holding region 11 is arranged above the window reveal and above the wall opening 27. Furthermore, the holding region 11 projects beyond the window reveal and the wall opening 27 laterally, preferably in both directions.

The wall 18 in FIG. 1 surrounds the wall opening 27 and transitions, in the region of the wall opening 27, into the window reveal 4.

Furthermore, in all embodiments of the apparatus according to the invention, an additional hook element 34 may be provided. Said hook element 34 prevents bending of the beam 1 as a result of the clamping forces. The beam 1 thus tends to deflect by arching upward as a result of an elastic deformation of the clamping parts 2, 6. At one side, the hook 34 is connected to the beam 1, and/or engages over the latter from above, in the middle region. At the other side, the hook 34 is hooked into the reveal 4 and/or is pressed from below by way of a projection against the underside of the upper reveal 4. Thus, the elastic bending of the beam 1 is counteracted. The forces are supported on the reveal 4. A further effect is that the clamping force is increased in this way.

FIG. 2 shows a detail of the illustration from FIG. 1, in particular in the region of the first clamping part 2.

The beam 1 is provided on the first clamping part 2, and is connected to the clamping part 2 in the first receiving region 5. The first clamping part 2 engages into the wall opening 27, in particular into the reveal 4. For this purpose, on the first clamping part 2, there is provided a first clamping projection 3 which, in the present illustration, runs substantially so as to project into the wall opening 27.

From the first clamping projection 3, a first spacer element 13 extends to the first receiving region 5. Said spacer element 13 is designed so as to realize a lateral projecting length 28 of the holding region 11. Furthermore, a projecting length 28 above the reveal is realized.

Furthermore, the first clamping part 2 comprises a first support projection 29. The latter extends into a region which is preferably situated below the first clamping projection 3. Furthermore, the first and the second support projections 29, 30 each comprise a second contact region 17.

Also provided in FIG. 2 is a holding groove 33. This depression is suitable, for example, for receiving one of the curtain rings or one of the connecting means and securing it against displacement. In this way, it is for example possible for a curtain to be fixed in position at one end. In the illustrated embodiment, the holding groove 33 is provided outside the region in which the second spacer elements 14 are connected to the receiving bushing 19. Thus, in this embodiment, the holding region 11 extends as far as said holding groove 33. In a further embodiment, it is however also possible for the holding groove 33 to be provided in the profile of the beam 1 or in the profile of the clamping part 2 or 6. It is substantially the case that, if holding grooves 33 are provided on both sides, the holding region 11 is situated between said two holding grooves 33.

FIG. 3 shows a clamping part 2 of the apparatus according to the invention in an oblique view. For example, the first clamping part 2 in FIG. 1 is designed in accordance with this embodiment. The two clamping parts 2, 6 are preferably of substantially mirror-symmetrical form, such that the two clamping parts 2, 6 have the same individual elements. It is however possible, if appropriate, for the first clamping part 2 and the second clamping part 6 to have one or more differences.

The first clamping part 2 comprises a first clamping projection 3, which projects into a window reveal 4 and which, by way of its side facing toward the reveal 4 and/or by way of the first contact region 16, bears against the reveal 4. From the first clamping projection 3, the first spacer element 13 extends out of the reveal 4 in the direction of the first receiving region 5. The first receiving region 5 is designed for receiving or fastening the beam 1, which is not shown in this illustration. The first spacer element 13 comprises a first section 31 which, proceeding from the first contact region 16 and/or from the first clamping projection 3, extends out of the wall opening 27 or out of the reveal 4 and to the side. Proceeding from said first section 31 of the spacer element, a second section 32 of the spacer element is provided, which second section extends away from the wall 18 and upward. The first receiving region 5 for the beam 1 is provided on said second section. In the present embodiment, the first receiving region 5 comprises a receiving bushing 19. In or on the receiving bushing 19 there is provided a first thread 9. A second thread 10 is for example provided on the beam 1. The two threads 9, 10 are in meshing engagement, wherein the screwing-in depth can be varied by relative rotation of the two threads 9, 10 with respect to one another. Furthermore, a first support projection 29 is also provided on the first clamping part 2. Said support projection extends downward from the first section 31 of the spacer element and/or from the second section 32 of the spacer element. Thus, the clamping part 2 comprises multiple individual elements which each perform one or more tasks:

The clamping projection 2 with the contact region situated thereon is designed for engaging into the wall opening 27 and for being pressed against the reveal 4. Said clamping projection extends substantially into the wall opening 27.

The first spacer element 13 is designed to position the receiving region 5 such that it is arranged, laterally offset, outside and above the reveal 4 and/or the wall opening 27. For this purpose, a first section 31 for a lateral offset and a second section 32 for an upward offset are provided. Furthermore, one of the two sections 31, 32 may also lead away from the wall 18 in order to effect positioning in front of the wall opening 27 and/or in front of the wall 18.

In this case, the holding apparatus is preferably designed such that the first clamping part 2 comprises a first spacer element 13 for the positioning of the first receiving region 5 outside the reveal 4 in a region to the side of and above the wall opening 27;

and such that the second clamping part 6 comprises a second spacer element 14 for positioning the second receiving region 8 outside the reveal 4 in a region to the side of and above the wall opening 27.

Furthermore, the spacer elements are designed for positioning the holding region outside and above the wall opening and for positioning the holding region such that it projects laterally beyond the masonry opening.

Furthermore, if appropriate, a first support projection 29 is provided. The latter preferably extends into a region below the first clamping projection 7. Owing to the weight force of a sheetlike element, said weight force being introduced in particular by the receiving region 5 into the clamping part 2, said forces must be supported on the wall 18 and/or on the reveal 4. The support is preferably realized via the second contact region 17 which, if appropriate, has an elastic and/or friction-increasing element 15.

In this case, the first clamping projection 3 projects, as described, into the reveal 4. It is preferably the case, as is also shown for example in FIGS. 1 and 2, that the clamping projection is arranged at the upper end of the reveal 4 and, in particular, bears against the upper surface such that a rotation of the one or more clamping parts about an axis parallel to the beam 1 is prevented. In this preferred positioning as per FIGS. 1 and 2, the clamping projections 3 and 7 bear against the upper subregion of the reveal.

FIG. 4 shows a schematic side view of the apparatus according to the invention, in particular of a clamping part 2 having a first receiving region 8, a first spacer element 13 and a first support projection 29. The first clamping part 2 furthermore comprises a receiving bushing 19 for receiving a beam 1. The first spacer element 13 is designed such that the first receiving region 8 is positioned remote from the wall 18 by a projecting length 28.

FIG. 5 shows a further embodiment of a clamping part of the holding apparatus according to the invention. For example, the second clamping part 6 in FIG. 1 is designed in accordance with this embodiment. Said clamping part in turn comprises a second clamping projection 7, a second spacer element 14 and a second receiving region 8, which comprises a receiving bushing 19. In the receiving bushing 19 there is provided a third thread 20. Furthermore, in the present embodiment, the clamping part comprises a second support projection 30. The viewing direction in FIG. 5 is directed substantially toward those surfaces of the clamping part which, in the normal install position, point in the direction of the wall and/or reveal. The second support projection 30 comprises an elastic element 15. Said elastic element is of substantially hemispherical form and projects out of the plane of the second support projection in the direction of the wall. Furthermore, the second clamping projection 7 also comprises an elastic element 15. Said elastic element is for example of areal form and is designed so as to follow the inner side of the solid part of the clamping projection and/or of the first contact region 16.

FIG. 6 shows a view of the apparatus illustrated in FIG. 5 from the left. In this case, the second clamping part 6 in turn comprises a second clamping projection 7 with a first contact region 16 on which an elastic element 15 is provided. Said elastic element extends areally along the first contact region 16.

In this embodiment, too, the receiving region 8 is connected by way of a second spacer element 14 to the second clamping projection 7. Furthermore, the second clamping part 6 comprises a first support projection 29 which comprises an elastic element 15 on the side facing toward the wall.

It should basically be noted that the elastic elements 15 of the different elements and regions of the clamping part 2 may vary in terms of their shape and size in accordance with the embodiment. For example, it is also possible for the elastic element of the clamping projection 3 to be in the form of an elastic element which makes contact in hemispherical or punctiform fashion. Furthermore, it is also possible for the spacer element 13 and/or the support projection 29 to comprise areally running elastic elements. For example, by way of a rubber coating over the full area or a coating composed of an elastic material over the full area, the entire contact region of the clamping part 2 against the wall and/or the reveal may be coated. An advantage of the elastic element or of the elastic elements is that, by means thereof, the clamping action is improved and the friction force is increased.

Furthermore, it should basically be noted that the first and second clamping parts 2, 6 are preferably of substantially mirror-symmetrical form.

Accordingly, a first clamping part 2 equivalent to the clamping part in FIGS. 5 and 6 would have a first clamping projection 3, a first receiving region 5, a first thread 9, a receiving bushing 19, possibly one or more elastic elements 15, a first spacer element 13, and possibly a first support projection 29. Said elements would, in terms of their function and action, be identical to the corresponding elements of the second clamping part 6. Differences may arise for example in the receiving region, as illustrated in FIG. 7.

FIG. 7a shows a section through a clamping part in the receiving region 5, in particular through a central axis of the receiving bushing 19, which will be described below. For receiving the beam 1, a receiving bushing 19 is provided. Said receiving bushing has a cup-shaped main body with a base 25. A first thread 9 is connected to said base 25, preferably by being screwed or pressed in. Between the first thread 9 and the receiving bushing 19 there is provided a space into which the beam 1 can be screwed.

FIG. 7b shows the same arrangement as FIG. 7a, but with a beam 1 screwed in. The beam 1 comprises a second thread 10 which is in the form of an internal thread and which can be placed in operative contact with the first thread 9 of the first receiving region 5. The screwing-in depth can be varied by rotation of the beam 1 relative to the first thread 9. A second position of the beam 1, in which it is screwed in to a greater depth, is schematically indicated by the reference sign 1′ and a dashed line.

The outer diameter of the beam 1 is in this case smaller than the inner diameter of the receiving bushing 19. In this way, the beam can be inserted and/or screwed into the receiving bushing 19. The second thread 10 is in this case provided directly on, and/or cut directly into, the inner side of the beam 1.

FIG. 7c illustrates a further embodiment in which the second thread 10 and the beam 1 are different, independent elements. The first thread 10 can be connected to the beam 1 by being pressed in or welded in or by way of other connecting methods. In this exemplary embodiment, the second thread is also in meshing engagement with the first thread 9, which is connected to the receiving region 5 and/or to the receiving bushing 19.

FIG. 7d shows a further embodiment of a possible design for the receiving bushing 19 and/or the receiving region 5. In this case, the beam 1 is again pushed into the receiving bushing 19. However, no threads are provided. Rather, the beam 1 is of substantially smooth form and can be pushed into the receiving bushing 19. An elastic element 15 is provided in the region of the base 25 of the receiving bushing. Said elastic element 15 serves for example as a stop and is if appropriate elastically formed when the beam 1 is inserted into the receiving bushing 19 or when a clamping force acts on the clamping parts.

Analogously to the exemplary embodiments above, it is also possible for the exemplary embodiments of FIGS. 7a, b, c, d to be provided in mirror-symmetrical or similar form on the first or on the second clamping part 6. In this case, the first thread 9 would correspond to the third thread 20, the second thread 10 would correspond to the fourth thread 21, and the first receiving region 5 would correspond to the second receiving region 8.

In the holding apparatus according to the invention, it is now possible for different embodiments of the receiving regions 5 to be combined with one another. For example, the first clamping part 2 and the second clamping part 6 may be designed in accordance with the embodiment as per FIG. 7b. For the engagement into the reveal 4 and for the positioning, according to the invention, of the holding region 11, the two clamping parts 2, 6 are of substantially mirror-symmetrical form about a vertical plane. Here, it is advantageous if the first and the second thread 9, 10 of the first clamping part 2 have an opposite thread orientation in relation to the third thread 20 and the fourth thread 21 of the second clamping part 6. In this way, a rotation of the beam relative to the two clamping parts 2, 6 has the effect that the two clamping parts 2, 6 are, depending on direction of rotation, moved or pushed either inward or outward. This gives rise to a centrally effected change in spacing of the two clamping projections 3, 7.

As a further alternative, it would be possible for the first clamping part to be configured with two threads which are placed in engagement, as per FIG. 7b or 7c, and for the second clamping part 6 to have a smooth bushing as per FIG. 7d. Thus, the change in length and/or the generation of a clamping force would be based on the screwing-in depth of a single thread pairing, in particular of the first and the second thread 9, 10. The side which is in the form of a smooth, freely rotatable bushing can absorb pressure forces for example by way of the elastic element 15, and introduce said pressure forces onward via the clamping apparatus into the wall and/or the reveal 4.

If both clamping parts 2, 6 have a thread pairing, it is possible for the clamping force and/or the spacing to be varied to a certain extent by rotation of the rod. It is preferably possible for the spacing of the two clamping parts 2, 6 or the screwing-in depth to be varied by approximately 5 to 20 cm, preferably by approximately 7.5 cm, per thread. Thus, in the case of two thread pairings being provided, it is possible for an overall spacing adjustment of 10 to 40 cm, preferably of approximately 15 cm, to be realized by rotation of the rods and variation of the screwing-in depths.

By contrast, if a thread pairing is used only on one clamping part 2, 6, and a smooth bushing is used on the other side in the case of the further clamping part 2, 6, only the change in length of one thread pairing is available. Consequently, a change in length only by one thread pitch is also realized per rotation, and not by two thread pitches, such as in the case of the provision of two identical and oppositely oriented thread flights. Accordingly, it is for example possible for the spacing of the two clamping parts or the screwing-in depth to be varied preferably by approximately 5 to 20 cm, preferably by approximately 7.5 cm.

The beam 1 is for example in the form of a circular-section rod 22. The receiving bushing 19 has a cylindrical opening 23, the inner diameter of which is preferably greater than the outer diameter of the rod 22. Furthermore, in the cylindrical opening 23 of the receiving bushing 19, concentrically with respect to the cylindrical opening 23, there is provided a threaded rod 24 which is connected to the base 25 of the receiving bushing 19 and which is in particular screwed into the base 25.

In an embodiment which is not illustrated, the beam 1 and in particular the circular-section rod 22 may have an external thread which can be screwed into an internal thread, wherein said internal thread is provided on the inner side of the receiving bushing 19.

FIG. 8 shows a further embodiment of a part of a clamping part similar to the embodiment of FIG. 3. In the present embodiment, the illustrated part of the clamping part corresponds to a first clamping part 2. As in all of the embodiments, the second clamping part could be of substantially mirror-symmetrical form. Said first clamping part 2 comprises a first clamping projection 3 for engagement into the reveal 4 (not illustrated). By contrast to the embodiment illustrated in FIG. 3, said clamping projection comprises an enlarged contact region which preferably extends away from the first spacer element 13. The receiving region 8 of the present construction is not illustrated in FIG. 8, but is preferably designed as in FIG. 3.

The construction of FIG. 8 comprises a first contact region 16 and, arranged below the first contact region 16, a second contact region 17. If appropriate, the two contact regions 16 and 17 may also be combined to form a single contact region. Furthermore, the first support projection 29 of the clamping part 2 preferably also comprises a second contact region 17. By means of this arrangement, the friction between the wall (not illustrated) or the reveal 4 (not illustrated) and the clamping part 2 is increased. A further difference in relation to the embodiment of FIG. 3 is the clearance 35. The latter is provided in that side of the clamping part 2 which points in the direction of the transition edge between the wall 18 and the reveal 4. To achieve the object of the invention, of providing a clamping apparatus with which the masonry is not destroyed, it is advantageous for the edge of the transition of the reveal to the wall also not to be damaged. Since, in some cases, said edge could be damaged by the clamping parts according to the invention, a clearance 5 is provided. Said clearance runs substantially parallel to the edge and prevents the clamping part 2 from coming into contact with said edge.

In a further embodiment, the described embodiments may have a receiving bushing 19 which permits an insertion depth of the beam of greater than 10 cm, preferably of approximately 14 cm.

Furthermore, the receiving bushings 19 may have chamfers on the edge facing toward the beam 1, in order that damage to the outer surface during the insertion of the beam 1 is prevented.

The above exemplary embodiments of the holding apparatus may all, in one embodiment, have a hook which reduces or prevents a deflection of the beam 1 as a result of the pressure load. Said hook may be hooked, at one side, onto the beam 1 and, at the other side, onto the reveal 4.

For the installation of the apparatus according to the invention, the following procedure may be followed: the holding apparatus is, in a first step, adapted approximately to the width of the reveal 4 such that the two clamping projections of the first and of the second clamping part 2, 6 can be inserted into the wall opening and/or into the reveal 4. In a second step, the apparatus is positioned at the upper end of the wall opening 27. There, a process of rotating the beam 1 is commenced, said rotation being performed until both clamping projections 2, 6 bear laterally against the reveal 4. By further rotation, a clamping force is generated. Said clamping force results, in combination with the friction coefficient in the contact region, in a friction force which is directed substantially counter to the weight forces of the apparatus and/or of the weight forces of the sheetlike elements acting on said apparatus.

The maximum friction force is greater the higher the friction coefficient of the contact region and/or the clamping force is. When the desired clamping force has been reached, the holding apparatus can be released. Owing to the bracing action in the reveal 4, the holding apparatus is secured so as to be prevented from falling down. Subsequently, sheetlike elements such as for example curtains or roller blinds can be mounted in the holding region 11 for example by way of rings, rails, clips or similar mounting means.

As emerges from the introductory part of the description, it is, according to the invention, advantageous for the holding region 11 to be provided above and outside the reveal 4 and/or the wall opening 27. Furthermore, the holding region 11 also extends beyond the wall opening to both sides.

### REFERENCE NUMERALS

1. Beam
2. First clamping part
3. First clamping projection
4. Reveal
5. First receiving region
6. Second clamping part
7. Second clamping projection
8. Second receiving region
9. First thread
10. Second thread
11. Holding region
12. Spacing of the clamping projections
13. First spacer element
14. Second spacer element
15. Elastic element
16. First contact region
17. Second contact region
18. Wall
19. Receiving bushing
20. Third thread
21. Fourth thread
22. Rail
23. Cylindrical opening
24. Threaded rod
25. Base
26. Internal thread
27. Wall opening
28. Projecting length
29. First support projection
30. Second support projection
31. First section, spacer element
32. Second section, spacer element
33. Holding groove
34. Hook element
35. Clearance

1-18. (canceled)

19. A holding apparatus for mounting a sheet-like element in front of a wall opening, comprising:
an elongate beam;
a first clamping part formed with a first clamping projection configured for engagement into a reveal delimiting the wall opening and with a first receiving region for receiving the beam;
a second clamping part formed with a second clamping projection configured for engagement into the reveal and with a second receiving region for receiving the beam;
a clamping part formed with a first thread in meshing engagement with a second thread provided on said beam;
wherein a relative movement of said first thread with respect to said second thread causes one or both of a screwing-in depth to be varied in order to effect clamping of the apparatus in the reveal or a change of a spacing between said first and second clamping projections; and
an elongate, substantially horizontally running holding region for receiving therein the sheet-like element, said holding region being arranged above and outside the wall opening and said holding region projecting laterally beyond the wall opening.

20. The holding apparatus according to claim 19, wherein:
said first clamping part comprises a first spacer element which extends from said first clamping projection out of the reveal into a region to a side of and above the wall opening as far as said first receiving region; and
said second clamping part comprises a second spacer element which extends from said second clamping projection out of the wall opening into a region to the side of and above the wall opening as far as said second receiving region.

21. The apparatus according to claim 19, which comprises at least one elastic element that is compressed under an influence of the clamping force.

22. The apparatus according to claim 19, wherein said elastic element is an element selected from the group consisting of a compression spring, a rubber buffer, an elastic layer and a friction-increasing layer.

23. The apparatus according to claim 19, wherein said first clamping projection has at least one first contact region, said second clamping projection has at least one first contact region, and, in an installed position, said contact regions are pressed against opposite regions of the reveal.

24. The apparatus according to claim 23, wherein each said clamping part has at least one second contact region which, in the installed position, is arranged below said first contact region.

25. The apparatus according to claim 24, wherein said second contact region, in the installed position, bears against the wall and/or is pressed against the reveal.

26. The apparatus according to claim 19, wherein said clamping parts, in their receiving regions, each comprise a receiving bushing into which said beam can be inserted or is inserted.

27. The apparatus according to claim 19, wherein said second thread is rigidly connected to said beam, and a rotation of said beam causes a spacing between said clamping projections and/or a clamping force to be varied.

28. The apparatus according to claim 19, wherein said second clamping part has a third thread and said beam has a fourth thread, and wherein said third thread and said fourth thread are in meshing engagement with one another.

29. The apparatus according to claim 29, wherein said third thread and said fourth thread have a thread direction of rotation opposed to a thread direction of rotation of said first thread and said second thread.

30. The apparatus according to claim 29, wherein said first, second, third, and fourth threads have central axes running substantially coaxially.

31. The apparatus according to claim 19, wherein said clamping projection comprises an elastic element which is pressed against the reveal and elastically deformed by the clamping force.

32. The apparatus according to claim 31, wherein said elastic element is an areal structure, following a fixed part of said clamping projection, and at least in the contact region of the clamping part.

33. The apparatus according to claim 19, wherein said beam is a circular-section rail, said receiving bushing is formed with a cylindrical opening having an inner diameter greater than an outer diameter of said rail, in that, in said cylindrical opening of said receiving bushing, and concentrically with respect to said cylindrical opening, there is provided a threaded rod which is connected to a base of said receiving bushing.

34. The apparatus according to claim 33, wherein said threaded rod is screwed into the base of said receiving bushing.

35. The apparatus according to claim 19, wherein a thread is formed with an internal thread which is in meshing engagement with said threaded rod of said clamping part, and wherein a central axis of said thread and a central axis of said beam run concentrically with respect to the central axis of said cylindrical opening.

36. The apparatus according to claim 19, wherein said receiving bushing is connected, in the receiving region, to said spacer element, and wherein said holding region extends over a part of said bushing as far as said spacer element or as far as said holding groove.

37. The apparatus according to claim 19, wherein the holding region extends over an entire free length of said beam.

38. The apparatus according to claim 19, configured to be installed without a use of tools and for mounting sheet-like elements selected from the group consisting of drapes, curtains, roller blinds, shutters, projection screens and the like in front of a wall opening.
